(19) United States
(12) Patent Application Publication
(10) Pub. No.: US 2012/0001433 A1
(43) Pub. Date: Jan. 5, 2012

(54) Fluid Driven Wheel System For Generating Electricity

(76) Inventor: Antoine Mowad, Waterbury, CT (US)

(21) Appl. No.: 12/830,333

(22) Filed: Jul. 4, 2010

(51) Int. Cl. F03B 13/08; F03B 17/04

(52) U.S. Cl. 290/54; 415/916

(57) ABSTRACT

A fluid driven wheel system for generating electricity has a double wheel assembly having a pair of identical wheels mounted in a vertical orientation on a horizontal axle. Fluid receptacles are connected to the wheels adjacent to the perimeters of the wheels and interconnect the wheels. Each fluid receptacle has a single opening for receiving fluid when the fluid receptacle is in a first orientation and for emptying fluid from the fluid receptacle when the fluid receptacle is in a second orientation. The fluid driven wheel system further comprises a pair of momentum wheels. Each momentum wheel is located on a corresponding side of the wheel assembly and is mounted on the horizontal axle so that the wheel assembly rotates with the momentum wheels. Each momentum wheel has a plurality of equidistantly spaced weighted members that provides a smooth, continuous movement of the wheel assembly.

### CROSS-REFERENCE TO RELATED APPLICATIONS

None.

### TECHNICAL FIELD

The present invention generally relates to a fluid driven wheel system for generating electricity.

### BACKGROUND ART

Water wheel systems for generating electricity are described in U.S. Pat. Nos. 7,222,487, 5,755,553, 3,984,698 and 224,299, and French Patent Nos. FR2931520 and FR2667204.

### DISCLOSURE OF THE INVENTION

The present invention is directed to a fluid driven wheel system for generating electricity. In one embodiment of the invention, the fluid driven wheel system comprises a double wheel assembly comprising a pair of identical wheels mounted in a vertical orientation on a horizontal axle. The wheel assembly has a front end and rear end and each wheel has a perimeter. The fluid driven wheel system includes a support structure for supporting the double wheel assembly. The fluid driven wheel system further comprises a fluid emission assembly located above the double wheel assembly for emitting fluid. The fluid driven wheel system further comprises a plurality of fluid receptacles connected to the wheels adjacent to the perimeters of the wheels. Each fluid receptacle is positioned between the wheels and interconnects the wheels. Each fluid receptacle has a single opening for receiving fluid when the fluid receptacle is in a first orientation and for emptying fluid from the fluid receptacle when the fluid receptacle is in a second orientation. The fluid receptacles are arranged such that all of the openings are oriented in the same direction so that the fluid receptacles are filled with fluids when the fluid receptacles pass under the fluid emission assembly and emptied when the fluid receptacles are located at the bottom of the wheel assembly. The fluid receptacles on the front end of the wheel having fluid therein and the empty fluid receptacles on the rear end of the wheel assembly cause the wheel assembly to rotate. The fluid driven wheel system further comprises a pair of momentum wheels. Each momentum wheel is located on a corresponding side of the wheel assembly and is mounted in a vertical orientation on the horizontal axle so that the wheel assembly rotates with the momentum wheels. Each momentum wheel has a plurality of equidistantly spaced weighted members that provide a smooth, continuous movement of the wheel assembly. The fluid driven wheel system further comprises a first gear box assembly driven by the horizontal axle, a fluid pumping assembly comprising a pump configured to be immersed in fluid and a drive member for driving the pump. The drive member is engaged with the first gear box assembly such that rotation of the wheel assembly causes movement of the drive member which in turn drives the pump. The fluid driven wheel system further comprises a fluid delivery conduit fluidly connected to the pump for delivering fluid pumped by the pump to the fluid emission assembly to fill the fluid receptacles with fluid. The fluid driven wheel system also comprises a second gear box assembly that is driven by the horizontal axle, and an electricity generating assembly comprising a generator that is driven by the second gear box assembly. The rotation of the horizontal axle drives the second gearbox which in turn drives the generator to generate electricity.

In a related aspect, the present invention is directed to a fluid driven wheel system for generating electricity, comprising a wheel assembly comprising a pair of identical wheels mounted in a vertical orientation on a horizontal axle. The wheel assembly has a front end and a rear end and each wheel has a perimeter. The fluid driven wheel system includes a support structure for supporting the wheel assembly. The fluid driven wheel system further comprises a fluid emission assembly located above the wheel assembly for emitting fluid. The fluid driven wheel system includes a plurality of fluid receptacles connected to the wheels adjacent to the perimeters of the wheels. Each fluid receptacle is positioned between and interconnects the wheels. Each fluid receptacle has a single opening for receiving fluid when the fluid receptacle is in a first orientation and emptying the fluid when the fluid receptacle is in a second orientation. The fluid receptacles are arranged such that all of the openings are oriented in the same direction so that the fluid receptacles are filled with fluids when the fluid receptacles pass under the fluid emission assembly and emptied when the fluid receptacles are positioned at the bottom of the wheel assembly. The fluid receptacles on the front end of the wheel having fluid therein and the empty fluid receptacles on the rear end of the wheel assembly cause the wheel assembly to rotate. The fluid driven wheel system further comprises a pair of momentum wheels. Each momentum wheel is located on a respective side of the wheel assembly and mounted in a vertical orientation on the horizontal axle so that the wheel assembly rotates with the momentum wheels. Each momentum wheel has a plurality of equidistantly spaced weighted members that provide a smooth, continuous movement of the wheel assembly. The fluid driven wheel system further comprises a fluid pumping assembly comprising a pump configured to be immersed in fluid, a drive member for driving the pump, and a fluid delivery conduit fluidly connected to the pump for delivering fluid pumped by the pump to the fluid emission assembly in order to fill the fluid receptacles with fluid. The fluid driven wheel system further comprises an electricity generating assembly comprising a generator. The fluid driven wheel system includes a drive system engaged with the horizontal axle for driving the drive member to effect pumping of fluid, and for driving the generator to generate electricity. Thus, rotation of wheel assembly causes the drive system to (1) drive the drive member so as to operate the pump, and (2) drive the generator.

Advantages and further features of the present invention are described in the ensuing description.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1A is a perspective view of a fluid driven wheel system for generating electricity in accordance with one embodiment of the present invention, the view showing the right side of the fluid driven wheel system;

FIG. 1B is an enlarged view of portion of the view of FIG. 1A, the view showing an RPM sensor that senses the RPM of the wheel assembly shown in FIG. 1A;

FIG. 2 is a perspective view of the fluid driven wheel system of FIG. 1A, the view showing the left side of the fluid driven wheel system;

FIG. 3 is a front view of the fluid driven wheel system of FIG. 1A;

FIG. 4A is a side view, in elevation, of a fluid receptacle shown in FIGS. 1A, 2 and 3;

FIG. 4B is a perspective view of the fluid receptacle shown in FIG. 4A;

FIG. 4C is a top view of the fluid receptacle shown in FIG. 4A;

FIG. 4D is a rear view of the fluid receptacle shown in FIG. 4A;

FIG. 5 is a side view, in elevation, of a momentum wheel shown in FIGS. 1A and 2;

FIG. 6 is a front end view of the momentum wheel of FIG. 5;

FIG. 7 is a perspective view of the momentum wheel of FIG. 5; and

FIG. 8 is a block diagram of a fluid driven wheel system for generating electricity in accordance with a further embodiment of the present invention.

### BEST MODE FOR CARRYING OUT THE INVENTION

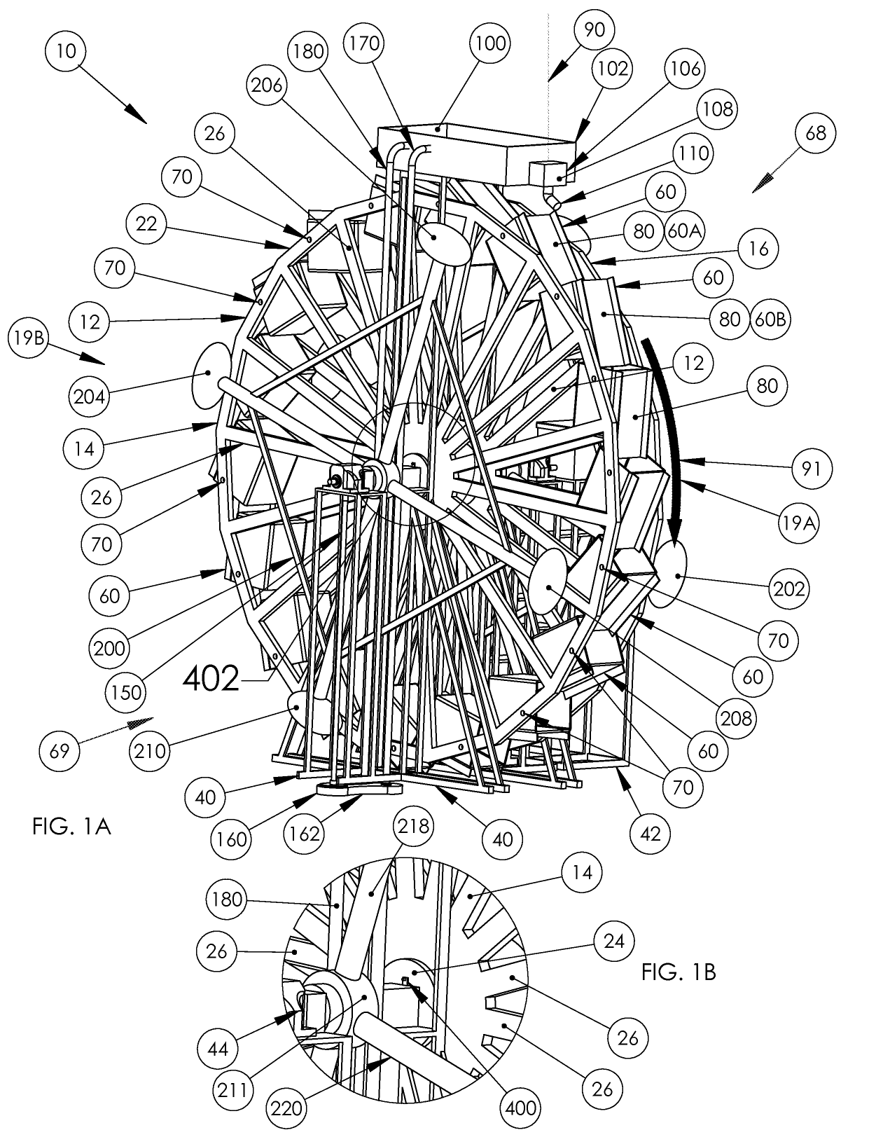

Referring to FIGS. 1A, 1B, 2 and 3 there is shown fluid driven wheel system 10 in accordance with one embodiment of the present invention. Fluid driven wheel system 10 comprises double wheel assembly 12 which comprises a pair of identical wheels 14 and 16 mounted in a vertical orientation on horizontal axle 18 such that wheels 14 and 16 rotate with horizontal axle 18. Double wheel assembly 12 has a front end 19A and rear end 19B. Wheel 14 has perimeter 22 and comprises hub portion 24 and support members 26 which extend radially from hub 24. Horizontal axle 18 passes through hub 24. Similarly, wheel 16 has perimeter 28 and comprises hub 30 and support members 32 that extend radially from hub 30. Horizontal axle 18 passes through hub 30. Wheels 14 and 16 can be made from any suitable material, such as wood, metal, plastic, rubber or composite materials. Fluid driven wheel system 10 includes vertically oriented support structures 40 and 42 which supports double wheel assembly 12 and other components of fluid driven wheel system 10. Vertically oriented support structures 40 and 42 may be made of any suitable material such as wood, metal, plastic, rubber or composite materials. Gear boxes 44 and 46 are positioned on the top of vertically oriented support structures 40 and 42, respectively. Gear box 44 is engaged with and driven by horizontal axle 18. Thus, the rotation of horizontal axle 18 drives gear box 44. Similarly, gear box 46 is engaged with and driven by horizontal axle 18. Thus, the rotation of horizontal axle 18 drives gear box 46. The purposes of gear boxes 44 and 46 are discussed in the ensuing description.

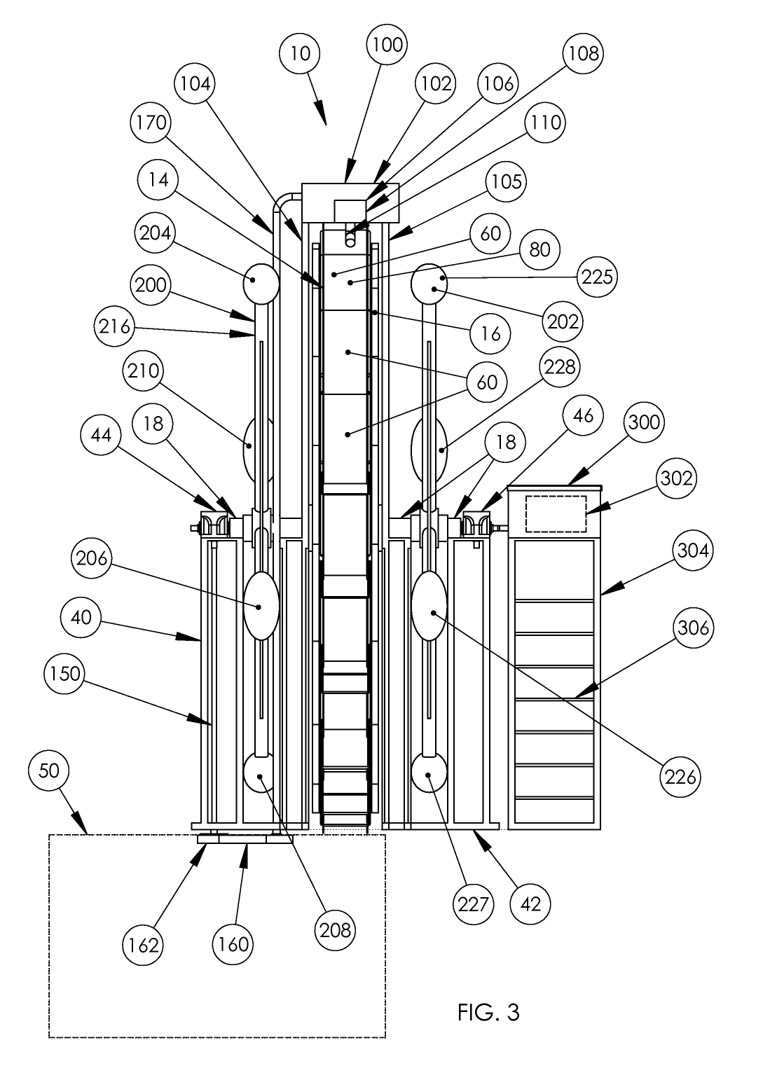

Referring to FIGS. 1A, 1B and 3, fluid driven wheel system 10 further comprises container 50 for holding fluids. Container 50 is located beneath double wheel assembly 10. Container 50 can be configured as a tank, tub, swimming pool or other suitable receptacle for holding fluids such as water. Container 50 may be made from any suitable material, such as such as wood, metal, plastic, rubber or composite materials.

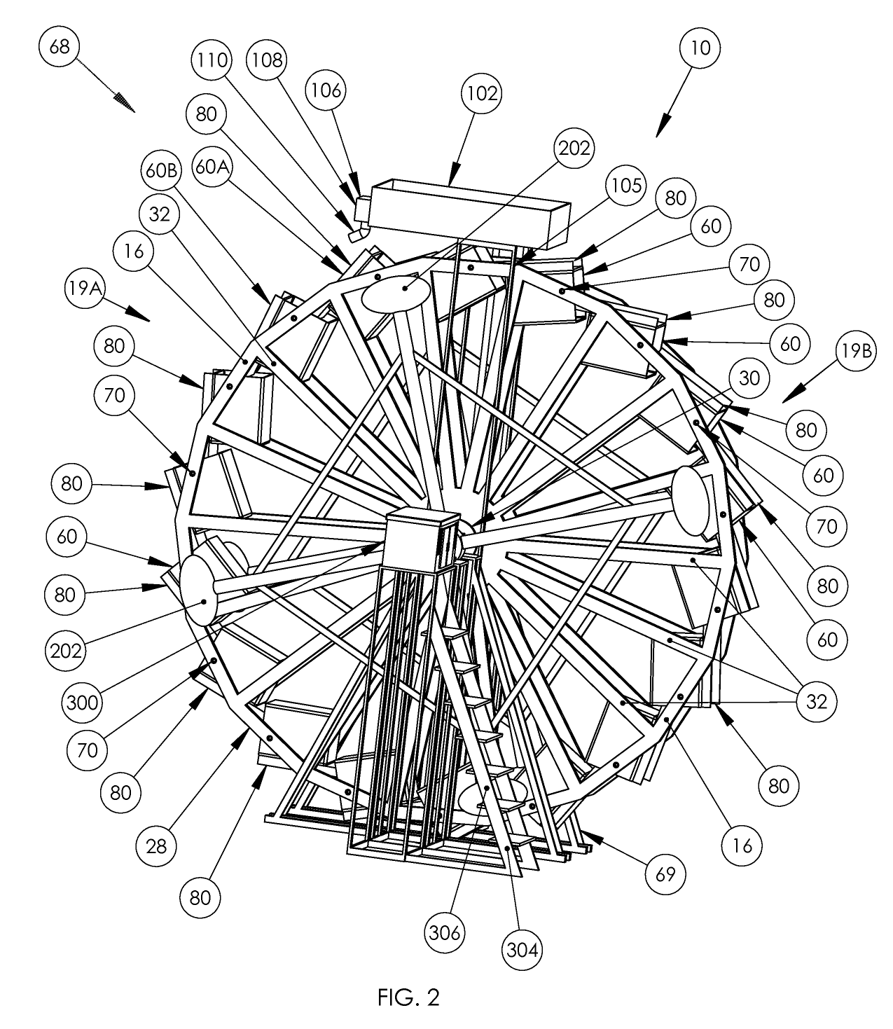

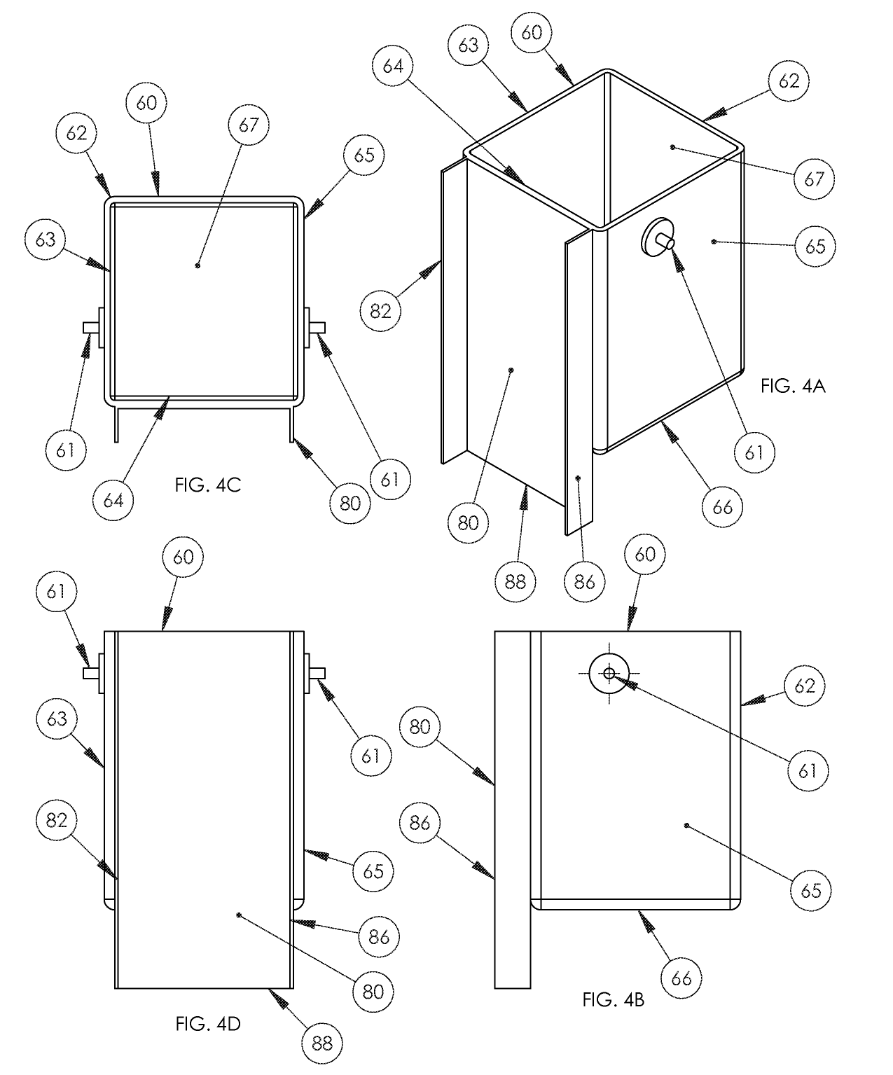

Referring again to FIGS. 1A, 1B, 2 and 3 and 4A-4D, fluid driven wheel system 10 further comprises a plurality of fluid receptacles 60 that are positioned between wheels 14 and 16. Fluid receptacles 60 interconnect wheels 14 and 16 such that wheels 14 and 16 rotate together. Fluid receptacles 60 are evenly spaced about perimeters 22 and 28 of wheels 14 and 16, respectively. Each fluid receptacle 60 comprises a pair of protruding members 61 that are sized to frictionally fit into corresponding openings 70 in wheels 14 and 16. Fluid receptacles 60 are rigidly attached to wheels 14 and 16. The method in which fluid receptacles 60 are rigidly connected to wheels 14 and 16 depend upon the materials from which wheels 14, 16 and fluid receptacles 60 are made. For example, if wheels 14, 16 and fluid receptacles 60 are fabricated from metal, then fluid receptacles 60 can be welded to wheels 14 and 16. In another embodiment, fluid receptacles 60 are bolted to wheels 14 and 16. Each fluid receptacle 60 comprises sides 62, 63, 64, 65 and bottom 66. Each fluid receptacle 60 has single opening 67 for receiving fluid when fluid receptacle 60 is in a first orientation as indicated by reference number 68 in FIGS. 1A and 2. When fluid receptacle 60 is in the second orientation, indicated by reference number 69 in FIGS. 1A and 2, fluid empties from each fluid receptacle 60 into container 50 (see FIG. 3). In a preferred embodiment, each fluid receptacle 60 is oriented at an angle of 30 degrees with respect to dashed reference line 90 that passes through fluid output device 106 (see FIG. 1A). Fluid receptacles 60 are arranged such that all openings 67 are oriented in the same direction so that fluid can be poured into fluid receptacles 60 as they passes under fluid output device 106. When each fluid receptacle 60 is positioned at the bottom of wheel assembly 12, the fluid flows out of fluid receptacle 60 and into container 50. As a result, empty fluid receptacles 60 are left on rear end 19B of wheel assembly 12. The fluid receptacles 60 containing fluid therein that are on front end 19A and the empty fluid receptacles 60 that are on rear end 19B result in the rotation of wheel assembly 12 as indicated by arrow 91 (see FIG. 1A).

Referring to FIGS. 1A, 3 and 4A-4D, each fluid receptacle 60 has a fluid trough 80 that receives fluid outputted by fluid output device 106. Fluid output device 106 is discussed in detail in the ensuing description. Each fluid trough 80 has sides 82 and 86, and open area 88. This particular shape of each fluid trough 80 cooperates with the orientation of fluid receptacles 60 so as to enable the fluid collected in fluid trough 80 of a fluid receptacle 60 that is currently receiving fluid from fluid output device 106 to flow through open area 88 and pour into the opening 67 of the adjacent fluid receptacle 60 that already passed under fluid output device 106. For example and referring to FIG. 1A, fluid trough 80 of receptacle 60A receives fluid from nozzle 110. The fluid trough 80 of fluid receptacle 60A passes the fluid to opening 67 of the adjacent fluid receptacle 60B which already had passed under nozzle 110. Such a configuration allows the aforesaid adjacent fluid receptacle 60B to continue filling with fluid even though it is no longer under nozzle 110.

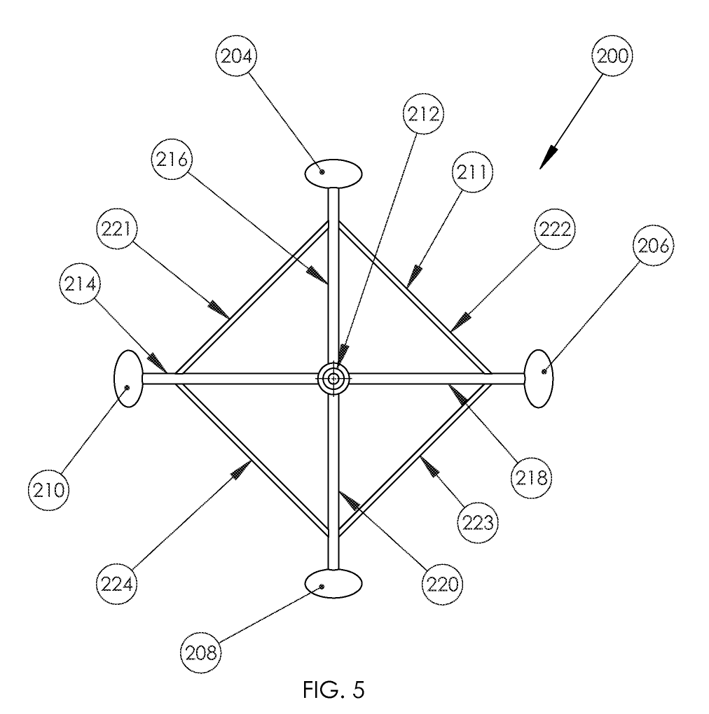

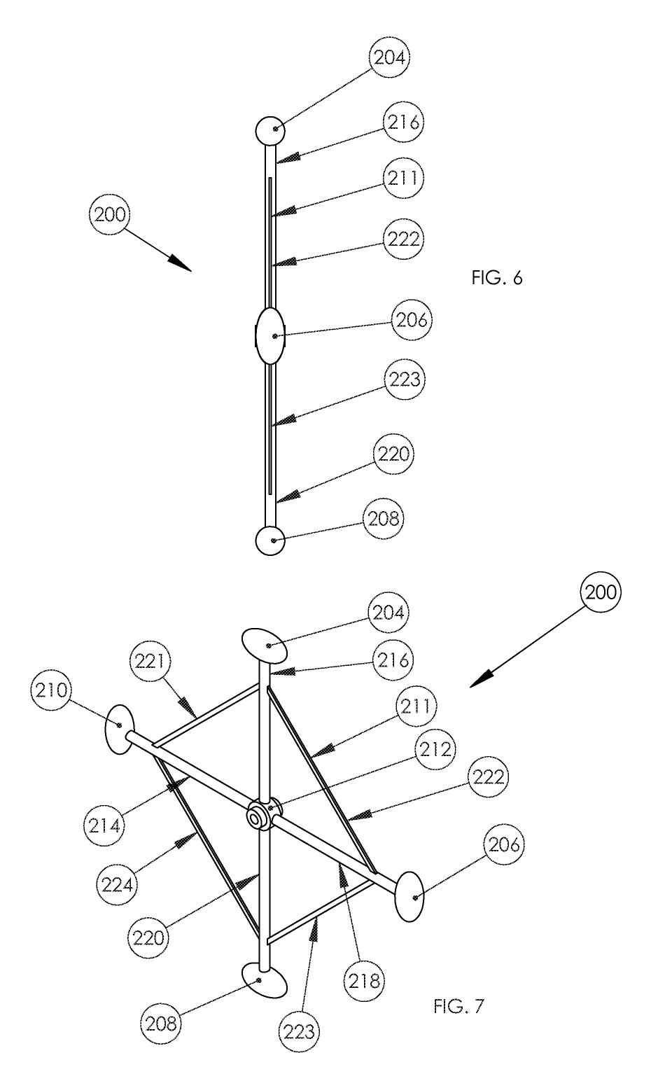

Referring to FIGS. 1A, 1B, 3, 5, 6 and 7, fluid driven wheel system 10 further comprises a pair of momentum wheels 200 and 202. Momentum wheels 200 and 202 are identically constructed. Wheel assembly 12 is located between momentum wheels 200 and 202. Each momentum wheel 200 and 202 is mounted in a vertical orientation on horizontal axle 18 such that wheel assembly 12 rotates with momentum wheels 200 and 202. Each momentum wheel 200 and 202 has a plurality of equidistantly spaced weighted members that enable wheel assembly 12 to rotate smoothly and continuously. Since momentum wheels 200 and 202 are identical in structure and function, FIGS. 5, 6 and 7 show only momentum wheel 200. Momentum wheel 200 comprises weighted members 204, 206, 208 and 210. Momentum wheel 200 further comprises frame 211 which comprises hub 212, beams 214, 216, 218, 220, as shown in FIG. 5, and support members 221, 222, 223 and 224. Beams 214, 216, 218 and 220 extend radially from hub 212. In a preferred embodiment, there are four weighted members 204, 206, 208 and 210 that are spaced about 90 degrees apart. In another embodiment, momentum wheel 200 has more than four weighted members. Support members 221, 222, 223 and 224 are connected to beams 216 and are arranged in a square shape. Horizontal axle 18 fits within hub 212. Thus, horizontal axle 18, wheels 14 and 16, and momentum wheels 200 and 202 all rotate together and simultaneously. Weighted members 204, 206, 208 and 210 can be made of any suitable material that will provide the desired weight. Such materials include wood, metal, plastic, rubber, glass, composite materials, etc. In one embodiment, each weighted member 204, 206, 208 and 210 is comprised of a hollow member that can be filled with a predetermined amount of a fluid, e.g. water. As shown in FIG. 3, momentum wheel 202 has weighted members 225, 226, 227 and 228.

Referring to FIGS. 1A, 2 and 3, fluid driven system 10 further comprises fluid emission assembly 100. Fluid emission assembly 100 comprises reservoir tank 102 and support structures 104 and 105 for supporting reservoir tank 102 above wheel assembly 12. Support structure 104 is attached to the top of support structure 40. Support structure 105 is attached to the top of support structure 42. Fluid emission assembly 100 further comprises fluid output device 106 that allows fluid to flow out of reservoir tank 102 and into fluid receptacles 60. Fluid output device 106 comprises variable flow pump 108 and nozzle 110 fluidly connected to variable flow pump 108. Nozzle 110 emits fluid provided by variable flow pump 108. Variable flow pump 108 includes an input for receiving a control signal that controls the amount of fluid pumped by variable flow pump 108. Nozzle 110 is positioned at a predetermined location so that nozzle 110 can eject a stream of fluid into fluid receptacles 60 as wheel assembly 12 rotates. In a preferred embodiment, nozzle 110 is adjustable.

Referring to FIGS. 2 and 3, gear box assembly 44 is located on top of support structure 40. Horizontal axle 18 drives and is engaged with gear box assembly 44. Thus, rotation of horizontal axle 18 drives gear box assembly 44. Vertically oriented torque shaft 150 is engaged with gear box assembly 44. As horizontal axle 18 rotates, gear box assembly 44 repetitively moves torque shaft 150 upward and downward. The purpose of this configuration will be apparent from the ensuing description.

Referring to FIGS. 1A and 3, fluid driven water system 10 further comprises fluid pumping assembly 160. In one embodiment, fluid pumping assembly 160 comprises at least one plunger pump 162 that is configured to be immersed in fluid (e.g. water). In a preferred embodiment, plunger pump 162 is immersed in the fluid that is within container 50 (see FIG. 3). The fluid is preferably water, but other suitable fluids can be used. It is to be understood that in lieu of container 50, plunger pump 160 can be placed in other sources of fluid, such as a pond, lake, swimming pool, puddle, etc. Fluid delivery conduit 170 is fluidly connected to plunger pump 160 and to reservoir tank 102 and delivers fluid pumped by plunger pump 160 to reservoir tank 102 so as to allow filling of fluid receptacles 60 with fluid. The upward and downward movement of torque shaft 150 drives plunger pump 160 and enables plunger pump 160 to pump the fluid from container 50 and into fluid delivery conduit 170. Fluid return conduit 180 delivers fluid overflow from reservoir tank 102 to container 50.

Referring to FIGS. 1A and 3, gear box assembly 46 is supported upon vertically oriented structure 42. Horizontal axle 18 drives and is engaged with gear box assembly 46. Fluid driven wheel system 10 further comprises electricity generating assembly 300 which comprises generator 302. Gear box assembly 46 drives generator 302. Thus, rotation of horizontal axle 18 drives gear box assembly 46 which in turn drives generator 302 so as to generate electricity. In an alternate embodiment, electricity generating assembly 302 is configured as the electricity generating assembly described in U.S. Pat. No. 7,222,487, the disclosure of which patent is hereby incorporated by reference. Electricity generating assembly 300 is supported by structure 304. In one embodiment, structure 304 comprises ladder 306. Ladder 306 enables a user to perform maintenance or repairs on electricity generating assembly 300. In an alternate embodiment, ladder 306 is not used and instead, a lift device such as an elevator is used.

Referring to FIGS. 1A and 1B, system 10 further comprises sensor 400 for sensing the rotational speed of wheel assembly 12. Sensor 400 outputs a control signal that controls variable flow pump 108. The position of sensor 400 is shown in FIG. 1B. FIG. 1B is an enlarged view of the portion of FIG. 1A referred to by reference number 402. The control signal outputted by sensor 400 represents the rotational speed of wheel assembly 12 and controls the rate at which variable flow pump 108 pumps fluid from reservoir tank 102. Thus, the rate at which variable flow pump 108 pumps fluid is based on the rotational speed of wheel assembly 12. Sensor 400 has inputs for receiving an electrical voltage that is provided by generator 302. Sensor 400 is stationary and in one embodiment, is mounted to support structure 40 near wheel 14 in order to sense the rotational speed of that wheel. In another embodiment, sensor 400 is mounted on support structure 42 near wheel 16. As shown in FIG. 1B, sensor 400 is mounted on support structure 40 near wheel 14 to sense the RPM (rotations per minute) of wheel 14. Electronic circuitry (not shown) is used to convert or process the electrical voltage/current outputted by generator 302 so as to provide a proper AC or DC voltage for use by sensor 400 and variable control pump 108.

The size (i.e. diameter) of wheel assembly 12 and the size of each fluid receptacle 60 depends upon the size of generator 302. The diameter of each of the momentum wheels 200 and 202 is generally the same as the diameter of wheel assembly 12. The actual weight of each of the weighted members 204, 206, 208 and 210 depends upon the size of generator 302.

System 10 provides many advantages over prior art systems. For example, momentum wheels 200 and 202 provide smooth and continuous movement of wheels 14 and 16 which, in turn, results in smooth and continuous rotation of the rotor of generator 302. Smooth and continuous rotation of the generator rotor yields an electric voltage/current output with relatively less ripple. Another advantage of the present invention results from the use of variable flow pump 108 which shoots out jets of fluid through nozzle 110. The jets of fluid have a velocity which increases the RPM (revolutions per minute) of wheels 14 and 16. The increased RPM of wheels 14 and 16 increases the generator RPM thereby resulting in at least a 10% increase in the electrical power provided by generator 302.

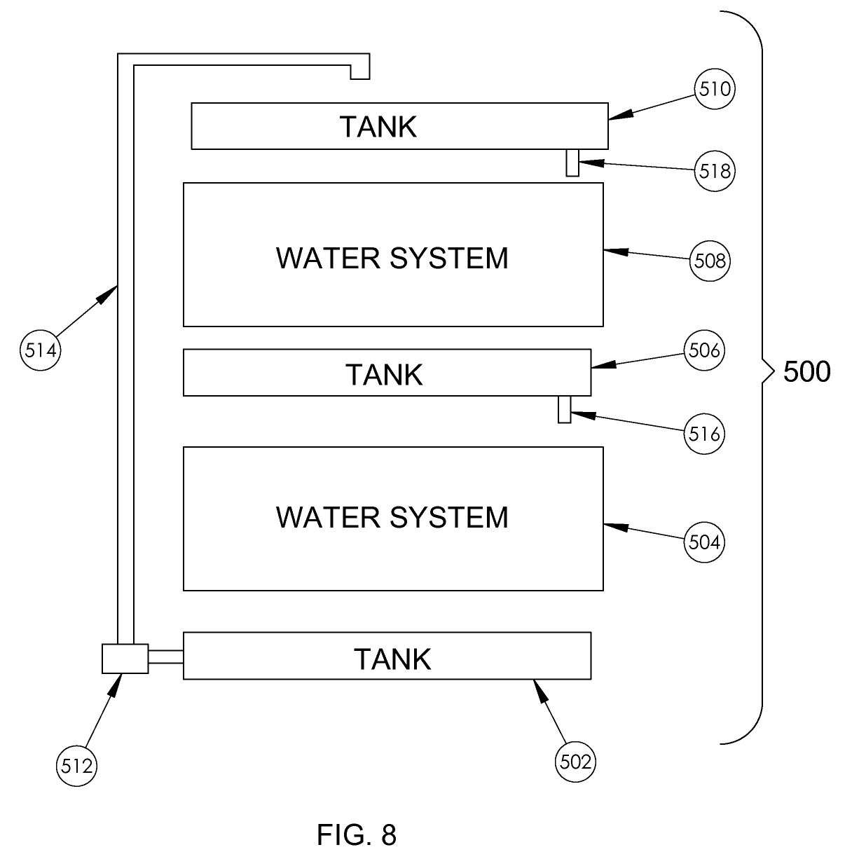

Referring to FIG. 8, there is shown fluid driven wheel system 500 in accordance with a further embodiment of the present invention. System 500 comprises a plurality of wheel systems arranged in a vertical configuration. In this particular embodiment, system 500 comprises lowermost fluid container or tank 502, wheel system 504, fluid container or tank 506, wheel system 508 and upper most fluid container or tank 510. Each wheel system 504 and 508 comprises a double wheel assembly, similar to double wheel assembly 12 (see FIG. 1A). Fluid tank 502 is located beneath the lowermost wheel system 504 and receives fluid from the fluid receptacles of wheel system 504. Fluid tank 506 is located between wheel system 504 and 508 and receives the fluid that is emptied from the fluid receptacles of wheel system 508. Fluid tank 510 is the uppermost fluid container or tank and disperses fluid to the fluid receptacles of wheel system 508. System 500 comprises pump device 512 and fluid conduit 514. Pump device 512 pumps fluid through fluid conduit 514 which delivers the fluid to uppermost fluid tank 510. In one embodiment, pump device 512 is a mechanical pump that is configured to function in the same manner as mechanical pump 160 shown in FIG. 1A. System 500 comprises a gear box assembly (not shown, but similar to gear box assembly 44) and a drive member (not shown but similar to drive member 150) to operate pump device 512. Fluid tanks 506 and 510 have fluid output devices 516 and 518, respectively. In a preferred embodiment, each fluid output device 516 and 518 is the same in construction and function as fluid output device 106 shown in FIG. 1A. Wheel system 508 comprises a second gear box assembly (not shown but similar to gear box assembly 46) and an electricity generating assembly that is generally the same in function and structure as electricity generating assembly 300 shown in FIG. 3. The aforesaid second gear box assembly of wheel system 508 drives the generator of the electricity generating assembly of wheel system 508. In one embodiment, wheel system 504 does not have an electricity generating assembly and all electricity generated by system 500 is produced by wheel system 508.

Referring again to FIG. 8, wheel system 504 comprises a sensor (not shown) that has the same function as sensor 400 (see FIG. 1B). Thus, the sensor in wheel system 504 controls each fluid output devices 516 and 518. In one embodiment, the sensor of wheel system 504 receives electrical power from the electricity generating assembly of wheel system 508. During operation of system 500, fluid output device 518 shoots fluid into the fluid receptacles of wheel system 508. The double wheel assembly in wheel system 508 rotates in the same manner as described for double wheel assembly 12 described in the foregoing description. As a result, wheel system 508 generates electricity which is delivered to the end user of the electricity. The fluid in the fluid receptacles of wheel system 508 empties into fluid tank 506. Fluid output device 516 shoots fluid into the fluid receptacles of wheel system 504. The double wheel assembly of wheel system 504 rotates in the same manner as double wheel assembly 12 and as a result, the fluid in the fluid receptacles of wheel system 504 empties into tank 502. Pump 512 pumps the fluid from tank 502 through fluid conduit 514 and into tank 510. If pump 512 is a mechanical pump, it does not use any electricity from wheel system 508 thereby significantly increasing the power available to the end user. Using a mechanical pump 512 can increase the electrical power available to the end user by at least 10%. In an alternate embodiment, wheel system 504 also comprises an electricity generating apparatus, similar to apparatus 300 shown in FIG. 3, for generating electricity. In such an embodiment, the total amount of electricity generated by system 500 is now higher because it is based on the electrical power provided by wheel system 504 and wheel system 508. If wheel system 504 comprises an electricity generating assembly, then pump 512 can be configured as an electric pump which can be powered by the electricity generated by the electricity generating assembly of wheel system 504. If fluid output devices 516 and 518 are electrically controlled, then these devices as well may be powered by the electricity generated by wheel system 504. Similarly, the aforementioned sensor of wheel system 504 may be powered by the electricity generated by wheel system 504. Any electrical power generated by wheel system 504 and not consumed by the electric pump, fluid output devices 516 and 518, and the sensor, is used for other purposes.

It is to be understood that system 500 includes a support structure and support members that support fluid tanks 502, 506 and 510 and wheel systems 504 and 508.

System 500 can be located outdoors or indoors. For example, system 500 can be located in an enclosed building or structure.

It is also to be understood that, although system 500 shows two wheel systems 504 and 508, more than two wheel systems can be used. In such an embodiment, the wheel systems and corresponding number of fluid tanks are arranged in a vertical configuration wherein fluid from the lowermost fluid tank is pumped to the uppermost fluid tank. Such an embodiment provides a significantly higher electrical power output. In such an embodiment, some or all of the wheel systems comprise an electricity generating assembly, similar to electricity generating assembly 300, for generating electricity. In such an embodiment, the total amount of electrical power produced by the system is based on the electrical power produced by each wheel system that uses an electricity generating assembly. Some of this electrical power would be used to power electrical components such as electric pumps, fluid output devices and the sensor used to monitor the RPM of the lowermost wheel system.

In a further embodiment of the invention, a plurality of systems such as system 500 are arranged side by side to form a row of systems 500.

While the foregoing description is exemplary of the present invention, those of ordinary skill in the relevant arts will recognize the many variations, alterations, modifications, substitutions and the like are readily possible, especially in light of this description, the accompanying drawings and the claims drawn hereto. In any case, because the scope of the invention is much broader than any particular embodiment, the foregoing detailed description should not be construed as a limitation of the present invention, which is limited only by the claims appended hereto.

What is claimed is:

1. A fluid driven wheel system for generating electricity, comprising:
a wheel assembly comprising a pair of identical wheels mounted in a vertical orientation on a horizontal axle, the wheel assembly having a front end and a rear end and each wheel having a perimeter;
a support structure for supporting the wheel assembly;
a fluid emission assembly located above the wheel assembly for emitting fluid;
a plurality of fluid receptacles connected to the wheels adjacent to the perimeters of the wheels, each fluid receptacle being positioned between and interconnecting the wheels, each fluid receptacle having a single opening for receiving fluid when the fluid receptacle is in a first orientation and emptying the fluid when the fluid receptacle is in a second orientation, the fluid receptacles being arranged such that all of the openings are oriented in the same direction so that the fluid receptacles are filled with fluids when the fluid receptacles pass under the fluid emission assembly and emptied when the fluid receptacles are positioned at the bottom of the wheel assembly, whereby fluid receptacles on the front end of the wheel having fluid therein and empty fluid receptacles on the rear end of the wheel assembly cause the wheel assembly to rotate;
a pair of momentum wheels, each of which being located on a corresponding side of the wheel assembly and mounted in a vertical orientation on the horizontal axle so that the wheel assembly rotates with the momentum wheels, each momentum wheel having a plurality of equidistantly spaced weighted members that provides a smooth, continuous movement of the wheel assembly;
a fluid pumping assembly comprising a pump configured to be immersed in fluid, and a drive member for driving the pump;
a fluid delivery conduit fluidly connected to the pump for delivering fluid pumped by the pump to the fluid emission assembly;
an electricity generating assembly comprising a generator; and
a drive system engaged with the horizontal axle for driving the drive member to effect pumping of fluid, and to drive the generator to generate electricity, whereby rotation of the wheel assembly causes rotation of the horizontal axle which in turn drives the drive system.

2. The fluid driven wheel system according to claim 1 wherein the drive system comprises:
a first gear box assembly driven by the horizontal axle and engaged with the drive member such that rotation of the wheel assembly causes movement of the drive member which in turn drives the pump; and
a second gear box assembly driven by the horizontal axle and configured to drive the generator in response to rotation of the horizontal axle.

3. The fluid driven wheel system according to claim 2 wherein the drive member comprises a torque shaft.

4. The fluid driven wheel system according to claim 1 further comprising a fluid tank for holding fluids wherein the pump is submerged in the fluid in the fluid tank.

5. The fluid driven wheel system according to claim 4 wherein the fluid emission assembly comprises a reservoir tank and means for supporting the reservoir tank above the wheel assembly, the fluid delivery conduit being fluidly connected to the reservoir tank to deliver fluid pumped by the pump to the reservoir tank, the fluid emission assembly further comprising a fluid output device that allows fluid to flow from reservoir tank and into the fluid receptacles.

6. The fluid driven wheel system according to claim 5 further comprising a fluid return conduit to deliver fluid overflow from the reservoir tank to the fluid tank.

7. The fluid driven wheel system according to claim 5 wherein each fluid receptacle has a fluid trough that receives fluid outputted by the fluid output device, the shape of each fluid trough cooperating with the orientation of the fluid receptacles to enable the fluid collected on a fluid trough of one fluid receptacle to pour into the single opening of an adjacent fluid receptacle after that single opening of the adjacent fluid receptacle passes under the fluid output device.

8. The fluid driven wheel system according to claim 7 wherein the fluid output device comprises a variable flow pump and a nozzle fluidly connected to the variable flow pump to emit fluid provided by the variable flow pump, the variable flow pump having an input for receiving a control signal that controls the amount of fluid pumped by the variable flow pump, the nozzle being positioned so as to eject a stream of fluid into the fluid receptacles as the wheel assembly rotates.

9. The fluid driven wheel system according to claim 8 wherein the nozzle comprises an adjustable nozzle.

10. The fluid driven wheel system according to claim 8 further comprising a sensor for sensing the rotational speed of the wheel assembly and outputting the control signal that controls the variable flow pump, wherein the control signal represents the rotational speed of the wheel assembly and wherein the rate at which the variable flow pump pumps water from the reservoir tank is based on the rotational speed of the wheel assembly.

11. The fluid driven wheel system apparatus according to claim 10 wherein the sensor has inputs for receiving an electrical voltage that is provided by the generator.

12. The fluid drive wheel system apparatus according to claim 1 wherein the plurality of weight members comprises four weight members that are spaced about 90 degrees apart.

13. A fluid driven wheel system for generating electricity, comprising:
a double wheel assembly comprising a pair of identical wheels mounted in a vertical orientation on a horizontal axle, each wheel having a perimeter;
a support structure for supporting the double wheel assembly;
a fluid source beneath the double wheel assembly;
a fluid emission assembly located above the double wheel assembly for emitting fluid;
a plurality of fluid receptacles connected to the wheels adjacent to the perimeters of the wheels, each fluid receptacle being positioned between and interconnecting the wheels, each fluid receptacle having a single opening for receiving fluid when the fluid receptacle is in a first orientation and for allowing the fluid to flow from the fluid receptacle when the fluid receptacle is in a second orientation, the fluid receptacles being arranged such that all of the openings are oriented in the same direction so that the fluid containers are filled with fluids when the fluid receptacles pass under the fluid emission assembly and the fluids flow out of the fluid receptacles when the fluid receptacles are positioned at the bottom of the wheel assembly, whereby fluid receptacles on the front end of the wheel having fluid therein and empty fluid receptacles are on the rear end of the wheel assembly cause rotation of the wheel assembly;
a pair of momentum wheels, each of which being located on a respective side of the wheel assembly and mounted in a vertical orientation on the horizontal axle so that the wheel assembly rotates with the momentum wheels, each momentum wheel having a plurality of equidistantly spaced weighted members that provides a smooth, continuous movement of the wheel assembly;
a first gear box assembly driven by the horizontal axle;
a fluid pumping assembly comprising a pump configured to be immersed in fluid, and a drive member for driving the pump, the drive member being engaged with the first gear box assembly such that rotation of the wheel assembly causes movement of the drive member which in turn drives the pump;
a fluid delivery conduit fluidly connected to the pump for delivering pumped fluid to the fluid emission assembly;
a second gear box assembly driven by the horizontal axle; and
an electricity generating assembly comprising a generator that is driven by the second gear box assembly whereby the second gear box assembly transfers the rotation of the wheel assembly to the generator to generate electricity.

14. A momentum wheel for use with a water wheel assembly configured to drive a generator, comprising:
a frame structure having a centrally located hub configured to receive a portion of an axle; and
a plurality of equidistantly spaced weight members attached to the frame structure.

15. The momentum wheel according to claim 11 wherein the plurality of weight members comprises four weight members spaced about 90 degrees apart.

16. A fluid driven wheel system for generating electricity, comprising:
a first fluid driven wheel system comprising a rotatable wheel structure, a plurality of fluid buckets attached to the rotatable wheel structure, and an electricity generating device that provides electricity when the wheel structure rotates;
an uppermost fluid tank positioned above the first fluid driven wheel system and having a fluid output device for dispensing fluid into the buckets of the first fluid driven wheel system;
an intermediate fluid tank positioned below the first fluid driven wheel system for receiving fluid emptied by the buckets of the first fluid driven wheel system and having a fluid output device for dispensing fluid;
a second fluid driven wheel system positioned below the intermediate fluid tank and comprising a rotatable wheel structure and a plurality of fluid buckets attached to the rotatable wheel structure, wherein the fluid output device of the intermediate fluid tank dispenses fluid into the buckets of the wheel structure of the second fluid driven wheel system;
a lowermost fluid tank positioned beneath the second fluid driven wheel system for receiving the fluid emptied by the buckets of the wheel structure of the second fluid driven wheel system;
a pump to pump fluid from the lowermost tank; and
a fluid delivery means for delivering the fluid pumped by the pump to the uppermost fluid tank.
